(19) United States
(12) Patent Application Publication
(10) Pub. No.: US 2023/0009672 A1
(43) Pub. Date: Jan. 12, 2023

(54) AUTOMATIC MODULATION OF DISPLAY TIMING BASED ON BEAT

(71) Applicant: SoClip!, Bandol (FR)

(72) Inventor: Christophe Vaucher, Bandol (FR)

(21) Appl. No.: 17/811,379

(22) Filed: Jul. 8, 2022

Related U.S. Application Data
(60) Provisional application No. 63/220,296, filed on Jul. 9, 2021.

(51) Int. Cl. G11B 27/00; G06T 15/00

(52) U.S. Cl. CPC G11B 27/005; G06T 15/005

(57) ABSTRACT

The disclosed technology provides solutions for enhancing a user's experience of music video playback. Beat temporal locations are identified in the soundtrack of a multimedia content item, and surround the beat temporal locations, the playback speed of video frames is adjusted. An audio event trigger is determined using a beat decomposition process that generates event vectors including time-index information, wherein the event vectors indicate temporal locations of the audio event trigger. Playback speed can be changed by advancing the timing of displayed frames before the occurrence of a rhythm event, and by delaying it after. Shader parameter courses can be changed by being accelerated before the occurrence of a rhythm event and by being decelerated after.

### CROSS-REFERENCE TO RELATED APPLICATION

This application claims priority to U.S. Provisional Application No. 63/220,296 filed Jul. 9, 2021, which is incorporated by reference herein in its entirety.

### FIELD

The present invention generally relates to a method for automatically adjusting the display of image frames of a video during playback and in particular, for locally accelerating/decelerating visual effect parameters and/or play speed characteristics of any music video in a manner that is temporally proximate to the local beat and/or to the local rhythm of the song used in the music video.

### BRIEF DESCRIPTION OF THE DRAWINGS

FIG. 1 illustrates an example graph of where triggers (also referred as “groovers” on the figure) can occur in an example song, according to some aspects of the disclosed technology.

FIG. 2 illustrates an example of various frame playback timing delays for a video that is not grooved, and a video that is grooved, according to some aspects of the disclosed technology.

FIG. 3 conceptually illustrates an example system that can be used to implement a video grooving process, according to some aspects of the disclosed technology.

FIG. 4A illustrates a conceptual block diagram of an example relationship between media file effects (“FX”) and shaders used to implement a desired effect, according to some aspects of the disclosed technology.

FIG. 4B is a graph illustrating an example of how a shader parameter can be modified using the groover graph, according to some aspects of the disclosed technology.

FIG. 5 illustrates an example of groover graphs that illustrates various time offsets (e.g., various groover strengths) that can be applied to the timing of frames with respect to a trigger time position, according to some aspects of the disclosed technology.

FIG. 6 illustrates an example of a derivative of a groover graph of relative frame display speed values, according to some aspects of the disclosed technology.

FIGS. 7 and 8 illustrate example groover graphs in which time-compression and time-stretching are illustrated.

FIG. 9 illustrates an example of a groover graph compression, e.g., where the compression magnitude is 400/500, according to some aspects of the disclosed technology

FIG. 10 illustrates an example in which a groover graph is used to provide time deceleration first, and acceleration after, according to some aspects of the disclosed technology.

FIG. 11 illustrates an example of a shader parameter graph (made of points and segments 1104) that has not been grooved, according to some aspects of the disclosed technology.

FIG. 12 illustrates an example of an interface that can provide a user/artist with the ability to interact with various shader parameter modes, according to some aspects of the disclosed technology.

FIG. 13 illustrates an example of an interface that can provide a user/artist with the ability set parameters for a BAR/measure cadence mode so that the shader parameter will follow the shader parameter graph, according to some aspects of the disclosed technology.

FIG. 14 provides an example graph illustrating an application of groover graphs to ‘bar cadenced’ shader parameters, according to some aspects of the disclosed technology.

FIG. 15 illustrates an example where groover is off, such as when the original shader parameter graph is not grooved, according to some aspects of the disclosed technology.

FIG. 16 provides an example graph illustrating the application of groover graphs to bar cadenced shader parameters, according to some aspects of the disclosed technology.

FIG. 17 provides an example graph illustrating the application of groover graphs to bar cadenced shader parameters.

FIG. 18 illustrates an example processor-based device that can be used to implement various aspects of the technology.

### SUMMARY

Disclosed are systems, apparatuses, methods, computer-readable medium, and circuits for identifying rhythm temporal locations (trigger locations) in the soundtrack of a multimedia content item and adjusting a playback speed of video frames around the trigger locations. According to at least one example, a method includes: identifying an audio event trigger and a frame playback rate of a multimedia content item; and adjusting a set of image frames of the multimedia content item based on the identified audio event trigger by using a groover graph to locally accelerate or decelerate the frame playback rate for the set of image frames surrounding the audio event trigger, wherein the groover graph includes a set of time offsets that can be applied to a timing of the image frames with respect to a temporal position of the audio event trigger, and wherein shifting is greatest for times nearest to the temporal position.

A similar method can be applied to groove shader parameters instead of the play speed of a video. According to at least one example, a method includes: identifying an audio event trigger and a shader parameter course; wiring a shader to one or more event vectors to automatically trigger certain graphical effects at times associated with the one or more of the event vectors during playback of an adjusted multimedia content item, wherein the shader is a function used to modify an appearance of a set of image frames; and locally accelerating or decelerating, at the identified audio event trigger, the shader parameter course by using a groover graph.

In another example, a program for identifying rhythm temporal locations (trigger locations) in the soundtrack of a multimedia content item and adjusting a playback speed of video frames around the trigger locations is provided that includes a storage (e.g., a memory configured to store data, such as virtual content data, one or more images, etc.) and one or more processors (e.g., implemented in circuitry) coupled to the memory and configured to execute instructions and, in conjunction with various components (e.g., a network interface, a display, an output device, etc.), cause the processors to perform operations comprising: identifying a first audio event trigger and a frame playback rate of a multimedia content item; adjusting a set of image frames of the multimedia content item based on the identified first audio event trigger by using a groover graph to locally accelerate or decelerate the frame playback rate for the set of image frames surrounding the identified first audio event trigger, wherein the groover graph includes a set of time offsets that can be applied to a timing of the image frames with respect to a temporal position of the identified first audio event trigger, and wherein shifting is greatest for times nearest to the temporal position; identifying a second audio event trigger and a shader parameter course; wiring a shader to one or more event vectors to automatically trigger certain graphical effects at times associated with the one or more of the event vectors during playback of an adjusted multimedia content item, wherein the shader is a function used to modify an appearance of a second set of image frames; and locally accelerating or decelerating, at the identified second audio event trigger, the shader parameter course by using the groover graph.

### DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Aspects of the disclosed technology provide solutions for enhancing a user's experience of content playback, such as that of a user that is viewing multimedia content such as a music video, on a display device, such as a smartphone or tablet computer. Although some of the examples described herein are discussed in relation to a mobile device, such as a smartphone, it is understood that the various aspects of the disclosed invention can be implemented on any device for which display parameters (e.g., a frame display speed) can be adjusted.

In some aspects, the disclosed technology identifies rhythm temporal locations in the soundtrack of a multimedia content item (e.g., audio event triggers) and adjusts a playback speed of video frames around the trigger locations. Depending on the desired implementation, triggers can correspond with the playback of different instrument types, or instrument combinations. However, in at least some approaches, triggers can represent locations in a song's playback duration where rhythm audio events (e.g. kick hits, snare hits, etc.) and/or singular audio events occur. In some aspects, the playback speed of a music video can be increased by advancing the timing of displayed frames before and after the occurrence of an audio event, i.e., a trigger. As discussed in further detail below, the audio triggers can correspond with rhythm audio events, such as kick hits and/or snare hits, etc.

In some aspects, the disclosed technology identifies rhythm temporal locations in the soundtrack of a multimedia content item (e.g., audio event triggers) and adjusts a playback speed of shader parameters around the trigger locations. Depending on the desired implementation, triggers can correspond with the playback of different instrument types, or instrument combinations. However, in at least some approaches, triggers can represent locations in a song's playback duration where rhythm audio events (e.g. kick hits, snare hits, etc.) and/or singular audio events occur. In some aspects, the original graph of shader parameters can be accelerated (respectively decelerated) before (respectively after) the occurrence of an audio event, i.e., a trigger, or the otherwise. As discussed in further detail below, the audio event triggers can correspond with rhythm audio events, such as kick hits and/or snare hits, etc.

In some implementations, trigger locations can be determined using a beat and/or rhythm decomposition process (e.g., a beat decomposition process), for example, that generates event vectors including time-index information. The vectors or numeric arrays can therefore indicate the temporal location of the triggers. Additional details regarding processes for analyzing and identifying audio artifacts in a musical composition (e.g., an audio file) are discussed in relation to U.S. application Ser. No. 16/503,379, entitled “BEAT DECOMPOSITION TO FACILITATE AUTOMATIC VIDEO EDITING,” which is herein incorporated by reference in its entirety.

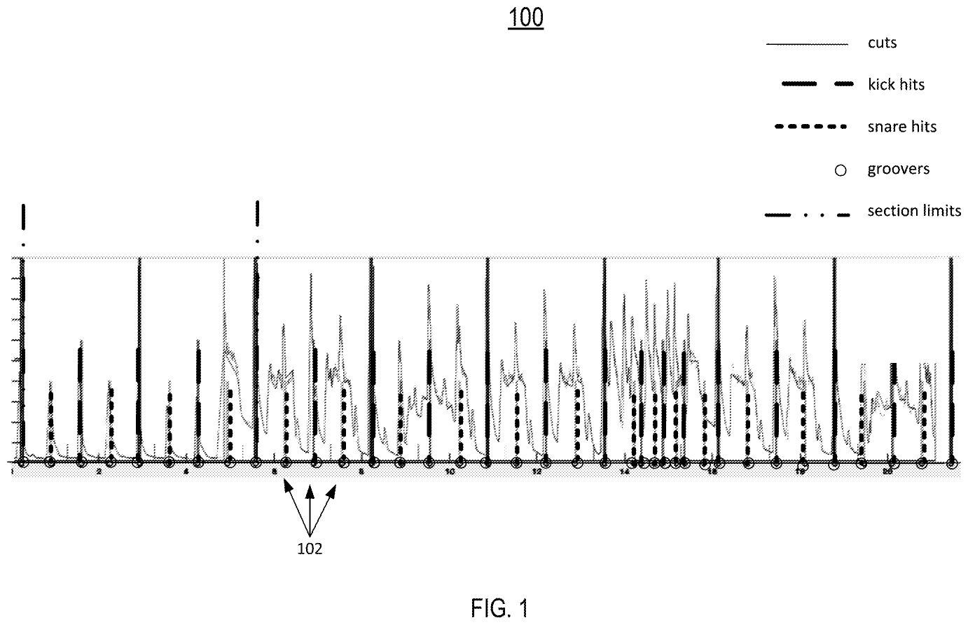

FIG. 1 illustrates an example graph 100 of where triggers can occur in an example song, i.e., AC/DC's Back in Black. In the example of FIG. 1, triggers 102 align with specific instrument events, e.g., kick/snare hits. However, it is understood that triggers can be designated for other instrument or audio event types. As discussed in further detail below, the triggers can indicate temporal locations that can be used to facilitate the adjustment of frame play speeds.

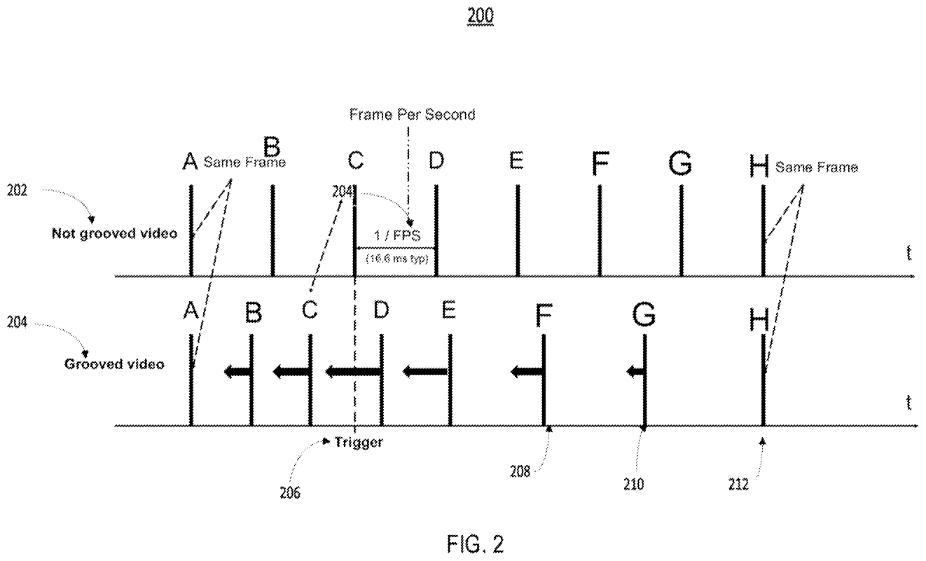

FIG. 2 illustrates an example 200 of various frame playback timing delays for a video that is not grooved 202, and a video that is grooved 204. In the illustrated example 200, the playback of one or more frames for the grooved video 204 is advanced in time before and after the occurrence of trigger 206. As illustrated by example, 200, a magnitude of frame advancement can be based on a distance from the trigger event. For example, in grooved video 204, the amount of time advancement for frame D (which is closest to trigger 206), is greater than the amount of time advancement for frame C, which is, in turn, closer to trigger 206 than frame B, etc.

As illustrated in example 200, the magnitude of frame advancement can decrease after the trigger event has passed. For example, a magnitude of playback time advancement of frame E is greater than a magnitude of playback time advancement of frame F, etc. Once the trigger 206 has passed, frame playback can resume to a normal speed. For example, frame H of grooved video 204, and frame H of un-grooved video 202 are played at the same time location.

With the above condition, a groover graph can be used to ensure that an overall duration of the media content playback is the same as that of the original media file. In this manner, lip-synced videos can be kept sensibly in-sync despite modifications that are made to the display of certain frames due to the grooving process. However, the present invention also covers a grooving process that would not be lip-sync compatible.

In some approaches, the processing necessary to determine trigger locations and frame playback rate information (e.g., using a groover graph), can be performed for a batch of media files. By way of example, triggers can be extracted for millions of MP3 files (e.g., using a beat/rhythm tracking process). Frame replay can then be adjusted based on the determined triggers by using a groover graph to locally accelerate/decelerate the frame display rate (e.g., the “play speed”) and or shader parameter courses.

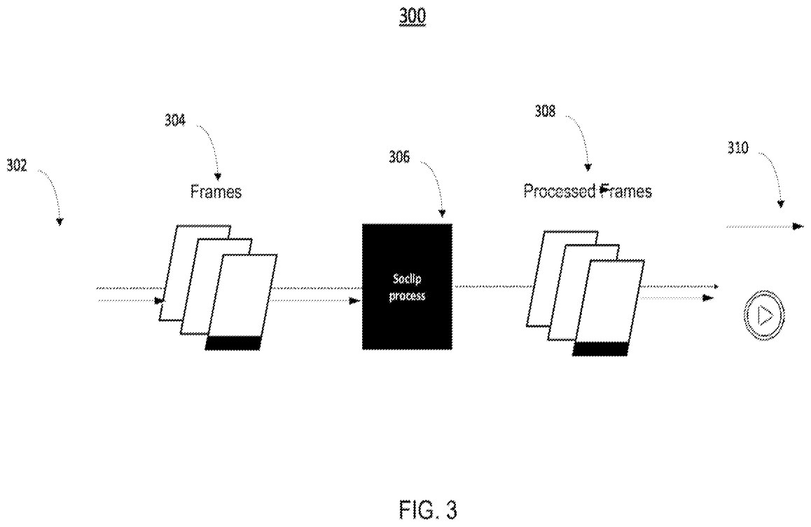

FIG. 3 conceptually illustrates an example system 300 that can be used to implement a video grooving process of the disclosed technology. In the example of FIG. 3, application processing 306 is performed on frames 304 as they are called from a customer's (user's) media decoder 302. Once the frames have been processed, for example, to perform video grooving, the resulting processed frames 308 are provided to the customer's media player 310 for playback. By pre-processing the frames 304 for playback, the groover process 306 can control the frame playback speed/timing, and thereby perform a time-advancement process of the disclosed technology.

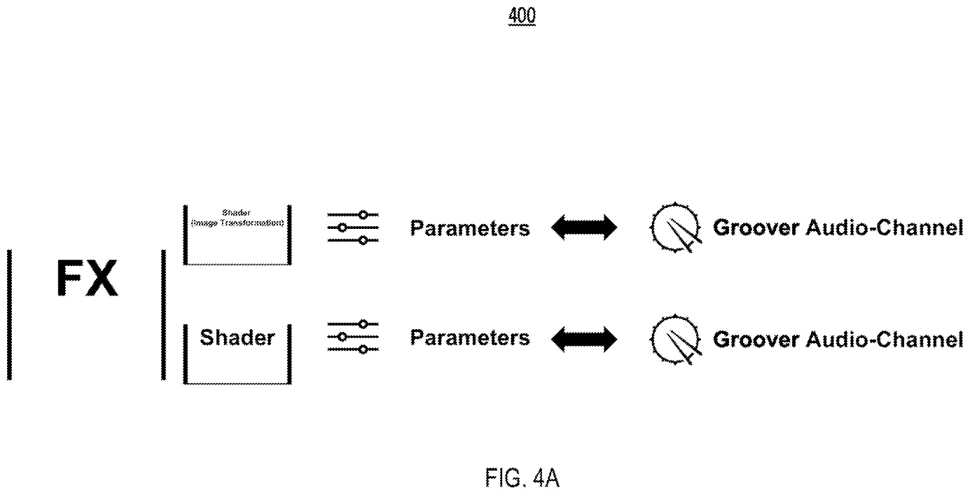

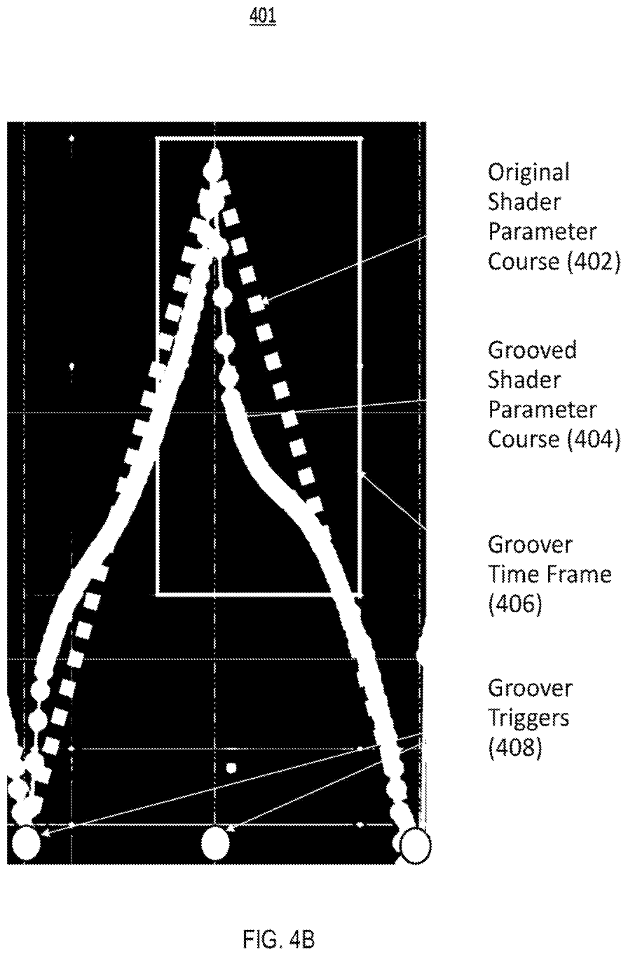

FIG. 4A illustrates a conceptual block diagram 400 of an example relationship between media file effects (“FX”) and shaders used to implement a desired effect. As used herein a shader can refer to any program or function used to modify the appearance of a rendered image, such as frames of a video. In some implementations, various shaders (or shader stacks) can be wired to vectors, such as specific audio channels, to automatically drive/trigger certain graphical effects at specific times during the playback of a media file.

As illustrated in the example of FIG. 4A, various FX can include a variety of different shaders, for example, that are applied to different audio channels. In some implementations, each applied shader can have its own unique set of image transformation properties. However, shaders can be applied together (as a stack) to accomplish the desired visual FX.

Changes to display properties can be user-configurable. For example, the magnitude and/or type of display change (as implemented by a shader) can be based on user-selectable parameters, and/or may be dependent on other user-configurable options. For example, display response can be a function of parameters implemented by user-configurable skin options that correspond with the playback of a particular media item, media type, and/or media collection (e.g., a playlist, etc.). Further details regarding the use of user-customizable skins are discussed in relation to U.S. application Ser. No. 16/854,062, entitled “AUTOMATED AUDIO-VIDEO CONTENT GENERATION,” which is herein incorporated by reference in its entirety.

FIG. 4B is a graph 401 illustrating an example of how a shader parameter can be modified/grooved using the groover graph, according to some aspects of the disclosed technology. As illustrated in example graph 401, an original shader parameter course 402 is illustrated with respect to time (x-axis), on which multiple groover triggers 408 are illustrated. A grooved shader parameter course 404, shows how the original shader parameter course 402 is modified based on a groover graph.

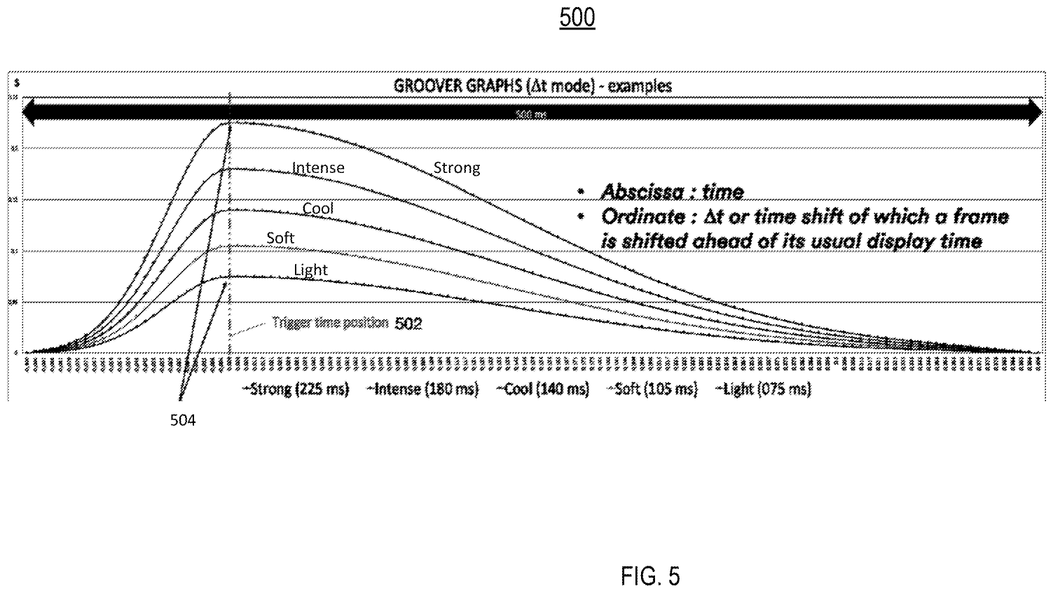

FIG. 5 illustrates an example of a groover graph 500 that illustrates various time offsets (Δt) that can be applied to the timing of frames with respect to a trigger time position 502. As illustrated in the example of groover graph 500, at the very beginning and very end of the graph Δt=0, and therefore the frame replay timing at those locations is the same as the original media file. However, Δt is greatest for times nearest to the trigger time position 502.

The magnitude of the applied offset (Δt) can correspond with the intensity of the audio waveform at a given trigger position. For example, at trigger time position 502, Δt can be greater if the corresponding audio event is of a high-intensity, and lower if the corresponding audio event is of a low-intensity. In some approaches, a predetermined discrete set of Δt values may be used, depending on the energy intensity of the audio at the trigger time. As illustrated in FIG. 5, Δt can values can be categorized as strong (225 ms), intense (180 ms), cool (140 ms), soft (105 ms), and light (75 ms). It is understood that a greater (or fewer) number of pre-determined Δt values may be used, without departing from the scope of the disclosed technology.

In some aspects, functions for calculating Δt values can be based on the Δt_{MAX} value 504 for a given groover graph, as well as the time position (t) within the graph, as given by equation (1):

$$Groover Graph ( \text{?} ) = \{ \text{?}$$

$$\text{?} \text{indicates text missing or illegible when filed}$$

It is understood that other mathematical functions may be used, without departing from the scope of the disclosed technology.

As discussed in further detail below, the groover graph can be calculated independently for each new media content item.

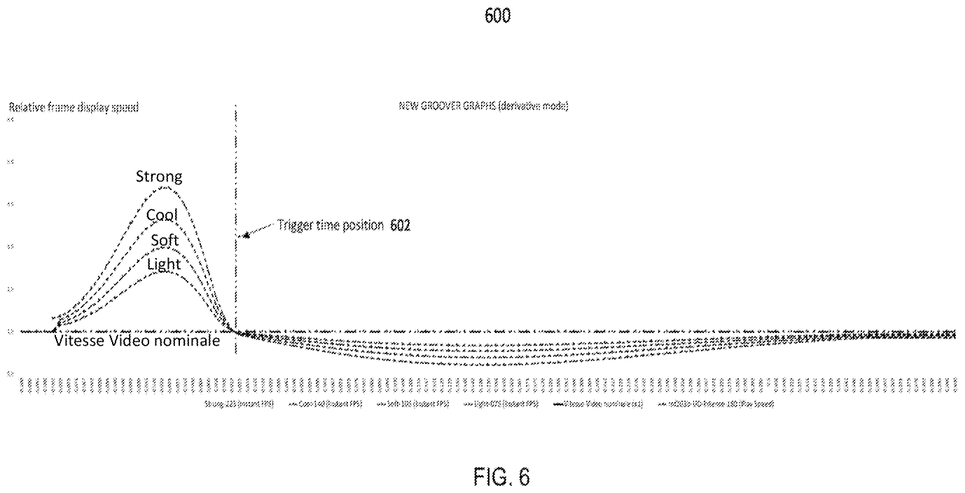

FIG. 6 illustrates an example of a derivative of a groover graph 600 of relative frame display speed values. In some aspects, it is preferable for the frame display speed to stay above 0, as many decoders (e.g., MP4 decoders) are not designed to read backward in real-time. Keeping the frame display speed above 0 implies severe constraints for the design of Δt mode graphs, as illustrated with respect to FIG. 5. In practice, it is preferable to keep the maximum advance of a frame to not more than 250 ms. However, absorbing the acceleration/deceleration time-shifts without producing a negative frame display speed can require time-compressing and/or time-stretching to be performed, for example, at the beginning and end of a song.

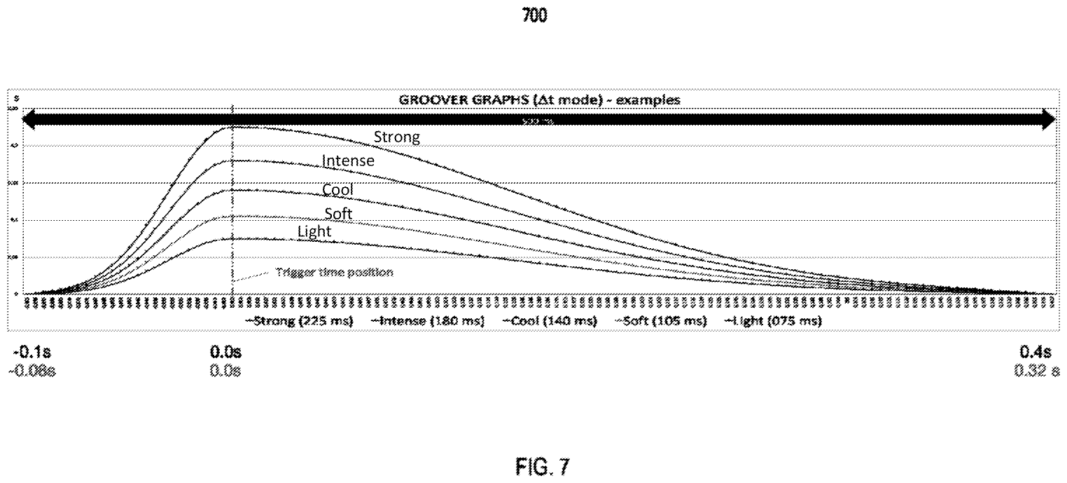

FIG. 7 illustrates an example of a groover graph (Δt mode) in which time-compression and time-stretching are illustrated. In some aspects, generation of the groover graph can assume that the main beat (e.g., the quarter note) of a given song is approximately constant for the song duration, for example, and typically ranging from 0.3 s to up to 1 s. Groover graphs can typically be designed for a song having a tempo (main beat) equal to 120 BPM (then having a 0.5 s quarter note) by way of example. Such groover graphs can typically start 0.1 s before the trigger and can typically end 0.4 s after the trigger. Time-compression and time-stretching can be performed in a manner that is based on the quarter note duration and/or other song parameters. By way of example, if the quarter note lasts 0.4 s (instead of 0.5 s), then the abscissa positions can be recalculated, and time compression/stretching adjustments are made, for example, in which the corresponding groover graph starts 0.08 s ahead of the trigger (instead of 0.1 s) and ends 0.32 s after the trigger (instead of 0.4).

In some approaches, it can be useful to attenuate the groover strength when time compressing a groover graph to ensure that the derivative of the frame play speed never occurs with a negative value. In some implementations, attenuation may only be necessary for songs having a quarter note duration less than about 0.5 s. In such instances, the groover strength can be attenuated by scaling the original Δt value by a factor that is based on the quarter note duration, such as a factor of:

$$\frac{Quarter Note Duration ( s )}{0.5 s}$$

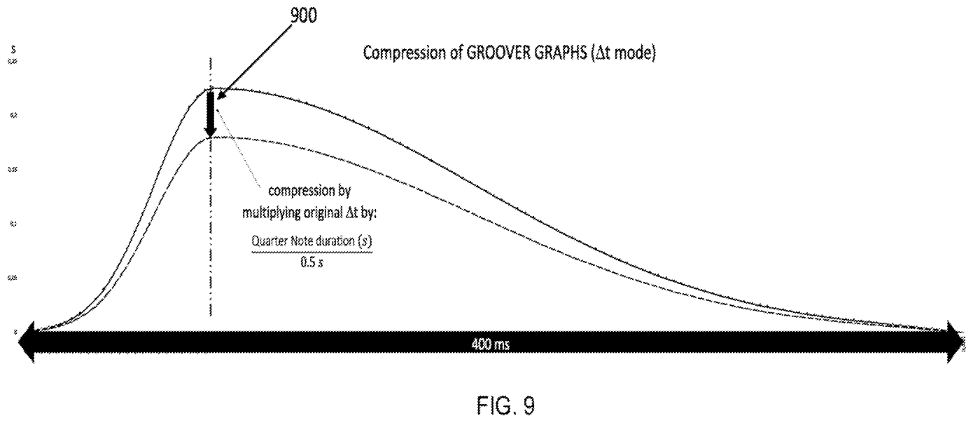

Appendix A, FIG. 9 illustrates an example of a groover graph compression, e.g., where the compression magnitude 900 is given by:

$$\frac{Quarter Note Duration ( s )}{0.5 s} ( Δ t )$$

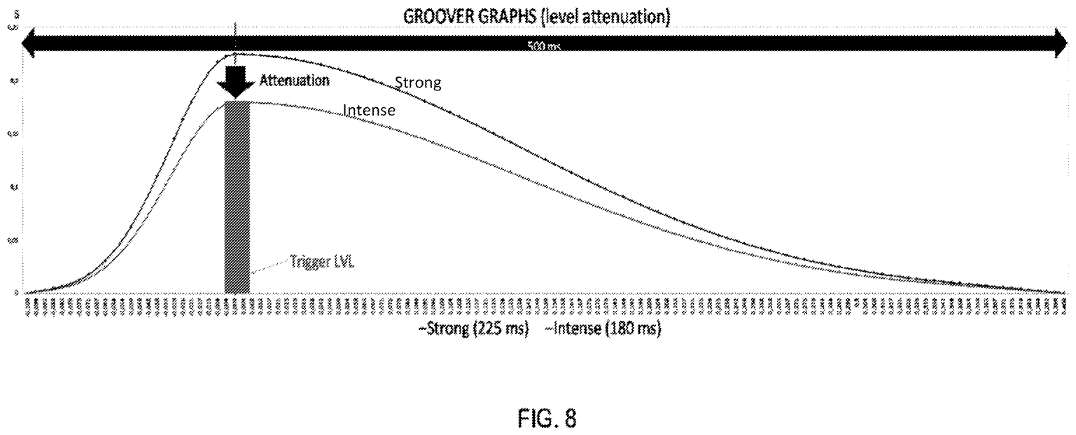

In some approaches, a relative energy level (LVL) for the rhythm audio event (typically, hit/snare) at a given trigger can be calculated and used to attenuate the groover strength. In some approaches, the calculated LVL (ranging from 0 to 1) can be used to scale the time shift value (Δt) by multiplying Δt by LVL^{Y} where Y can typically range between 0.50 and 2. An example of a level attenuation that is performed for the groover strength (e.g., based on a calculated LVL value) is depicted with respect to Appendix A, FIG. 8.

In some examples, multiple triggers (e.g., 2 or more triggers) may be close to one another in the groover-audio channel. In such instances, the Δt values can be summed at the same time positions. However, where Δt values are summed, it can be useful to cap the total, for example, so that the Δ_{MAX} never exceeds 250 ms on the 500 ms span graph.

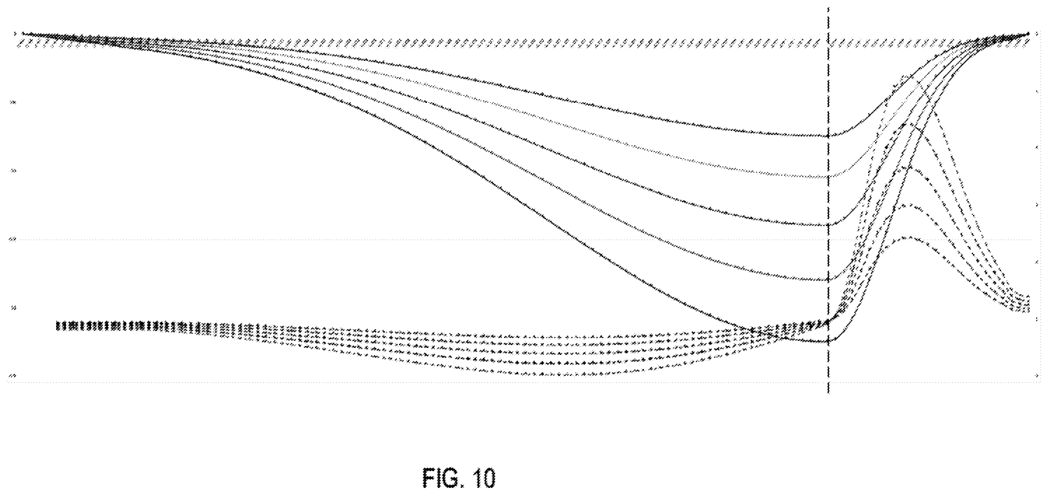

FIG. 10 illustrates an example in which a groover graph is used to provide time deceleration first (i.e., before a trigger), and acceleration after.

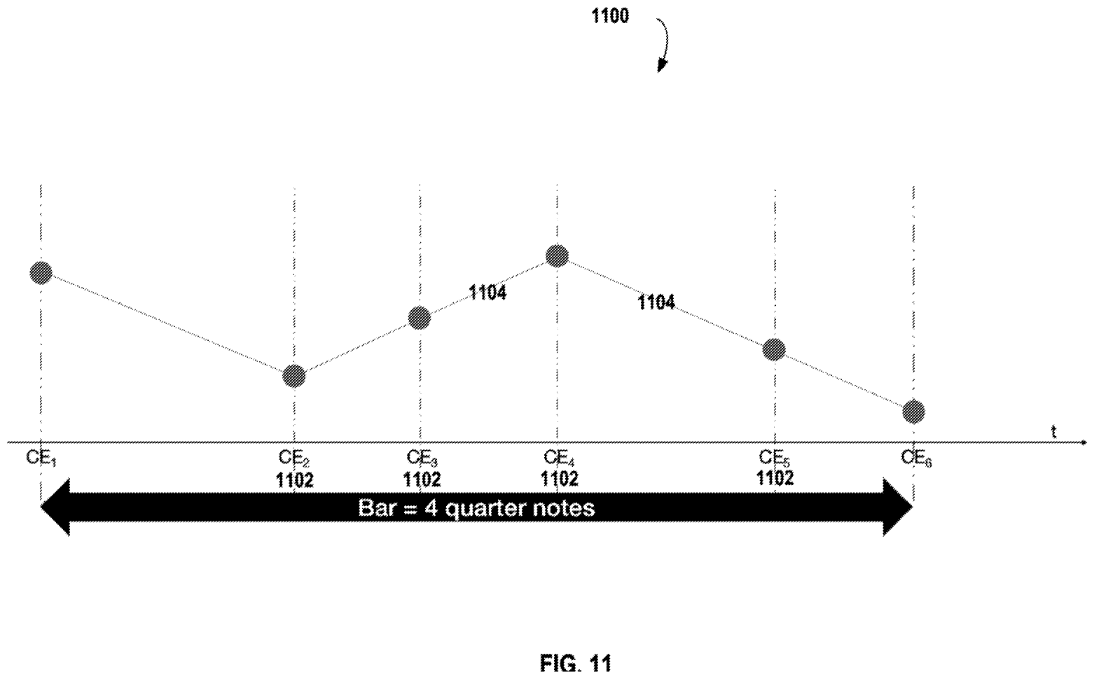

FIG. 11 illustrates an example of a shader parameter graph 1100 that has not been grooved, e.g., using a groover graph technique as discussed above with respect to Appendix A. In the example illustrated by shader parameter graph 1100, shader parameters can be automatically driven by cadencing trigger events (CEs) 1102, for example, that are identified based on musical events, such as, kick hits, snare hits, tom hit/s, etc. In a typical implementation, the shader graph may be designed by creative operators, for example, that can choose and/or edit various shader parameters associated with each bar (i.e., every four quarter notes). As illustrated in the example of shader parameter graph 1100, shader graphs can be typically comprised of a series of segments 1104 (it can also be “easing functions”) that are broken at points corresponding with various cadencing events 1102. In some implementations, the speed/performance of the editing process can be optimized by organizing creative design at bar increments (e.g., every four quarter notes), e.g., for the totality of the song's duration. However, it is understood that other musical patterns may be used, without departing from the scope of the disclosed technology.

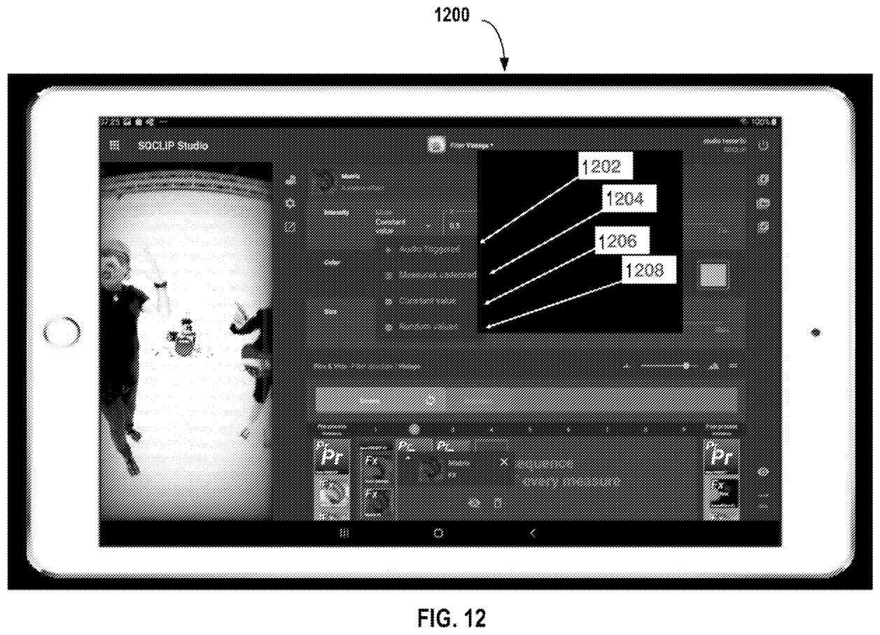

FIG. 12 illustrates an example of an interface 1200 that can provide a user/artist with the ability to interact with various shader parameter modes, for example, within the context of an editing software menu. In the example of FIG. 12, interface 1200 provides an auto triggered mode 1202, a measure cadence mode 1204, a constant value mode 1206, and a random values mode 1208. Although four (4) modes are illustrated with respect to example interface 1200, it is understood that additional (or fewer) modes may be implemented without departing from the scope of the disclosed technology.

In practice, the auto triggered mode 1202 can be used to trigger a specified shader parameter upon the detected occurrence of a predetermined audio event, such as, each time a particular song event (e.g., a kick hit, or snare hit, etc.) is detected. The measure cadence mode 1204 allows the shader parameter to be cadenced along a single measure (e.g., a BAR). In some implementations, the cadence measure can last a predetermined length of time, such as 2 seconds; however, different durations of time are contemplated, without departing from the scope of the disclosed technology. The constant value mode permits the user/artist to apply a constant shader parameter, e.g., for all times throughout the duration of the song. The random mode 1208, allows the shader parameter to be randomly set/selected, for example, within a predetermined interval that is specified by the user/artist, e.g., double slider that is displayed on interface 1200.

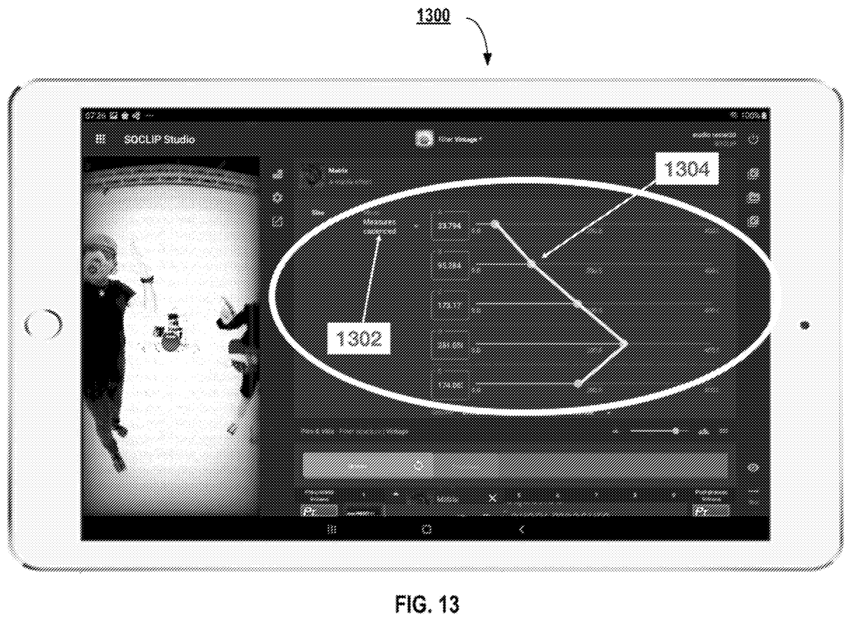

FIG. 13 illustrates an example of an interface 1300 that can provide a user/artist with the ability set parameters for a BAR/measure cadence mode 1302 so that the shader parameter will follow the shader parameter graph (as discussed above). In the example of interface 1300, the measure cadence mode 1302 can be user configured using various sliders 304 provided by interface 1300. Although five sliders 1304 are shown in the menu illustrated with respect to interface 1300, it is understood that a greater (or fewer) number of user-selectable options may be implemented, without departing from the scope of the disclosed technology.

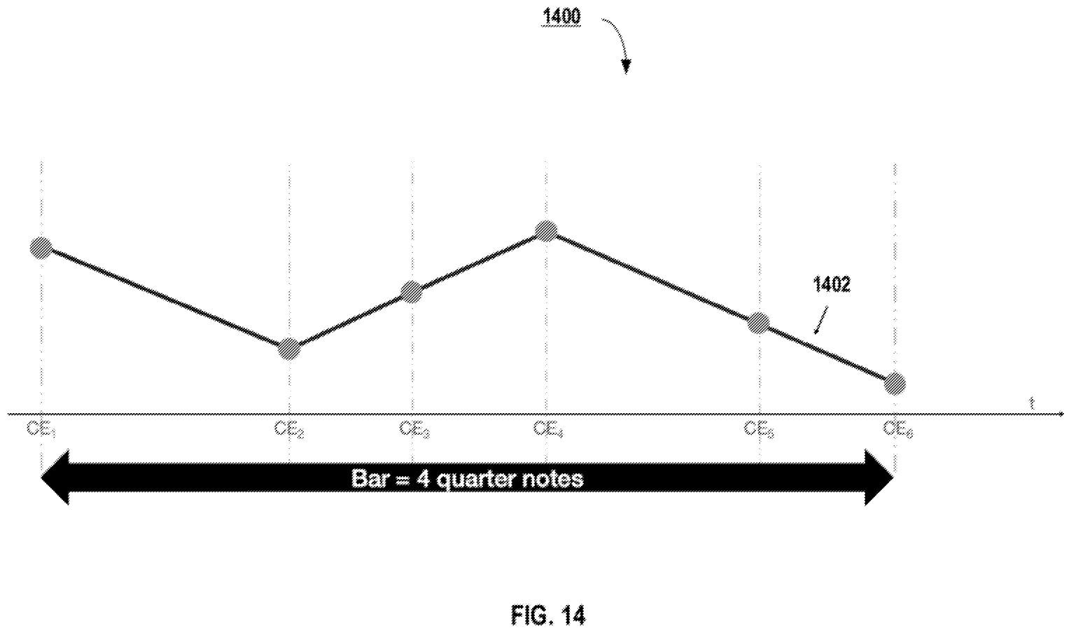

FIG. 14 provides an example graph 1400 illustrating an application of groover graphs to ‘bar cadenced’ shader parameters, according to some aspects of the disclosed technology. As illustrated in the example of FIG. 14, there are six cadencing events (CEs) per bar, where one bar equals four quarter notes. However, it is understood that there may be a different number of CEs per bar, and a greater (or fewer) number of quarter notes per bar, depending on the local rhythm of the corresponding song.

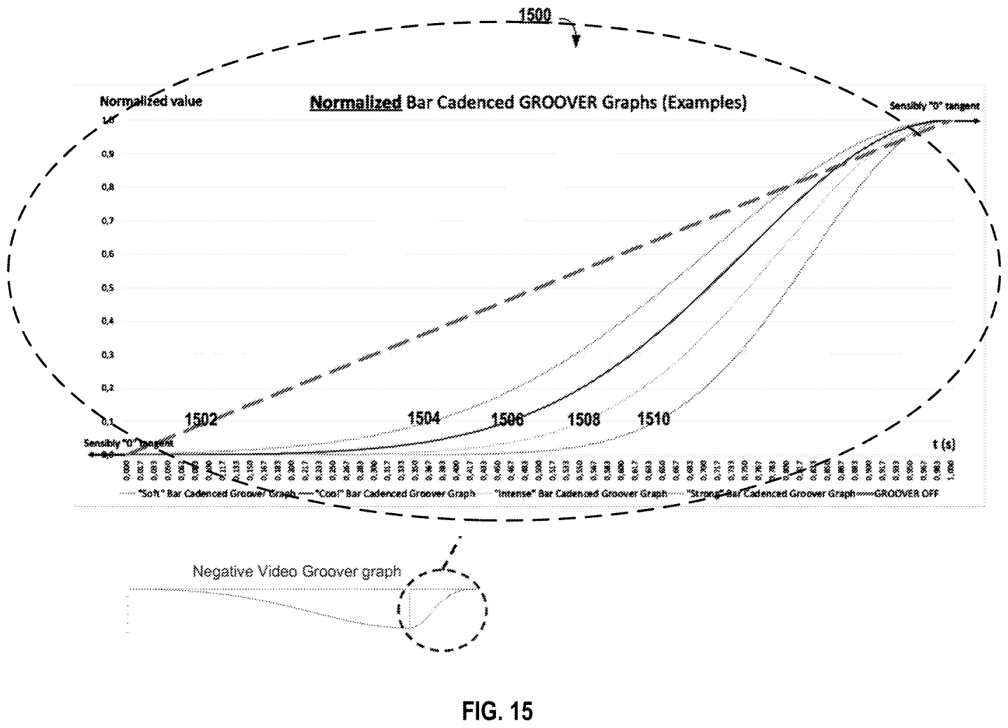

In some approaches, shader parameters can be automatically projected on local cadencing events (e.g., those in the current BAR). In order to make the shader parameters better match the musical groove, the bar cadenced shader graphs can be normalized to produce normalized bar cadenced groover graphs, as illustrated in FIG. 15.

FIG. 15 illustrates an example where groover is off, i.e., when the original shader parameter graph is not grooved 1502. The other graphs (e.g., 1504, 1506, 1508, and 1510) provide examples of normalized bar cadenced groover graphs, of varying intensity (e.g., soft 1504, cool 1506, intense 1508, and strong 1510), where time is defined between 0 and 1.

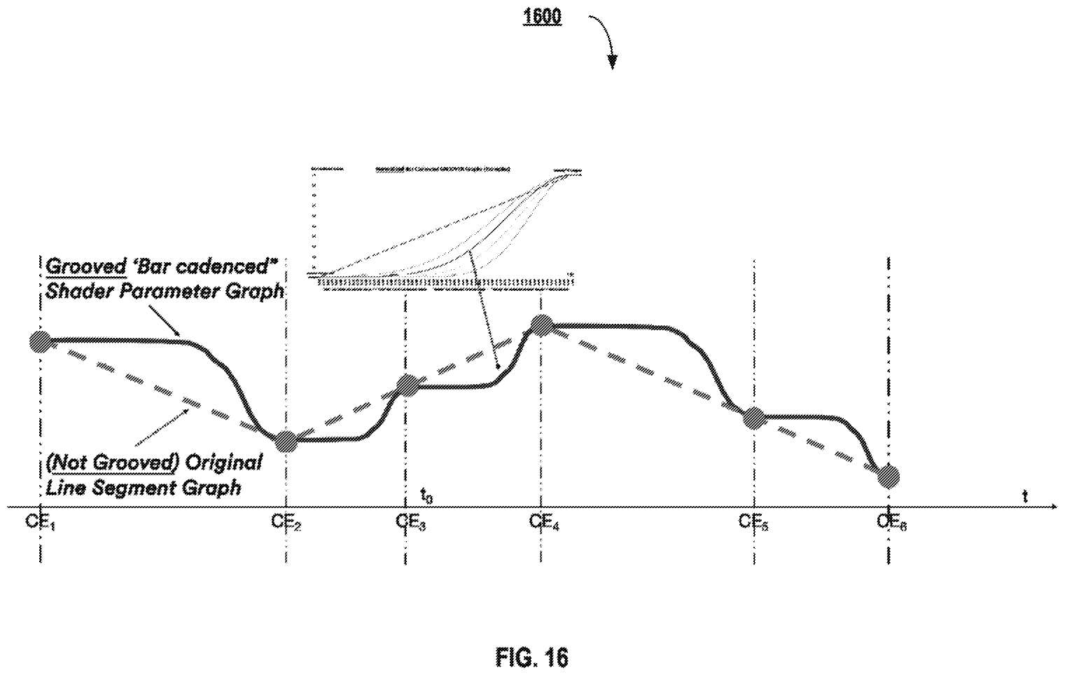

FIG. 16 provides an example graph 1600 illustrating the application of groover graphs to bar cadenced shader parameters, according to some aspects of the disclosed technology. In the example of FIG. 16, the grooved ‘bar cadenced” shader parameter is illustrated by the solid line, whereas the un-grooved original segment is illustrated as a dotted line. In some aspects, in order to ‘groove’ the original bar cadenced shader parameter graph, a normalized shader parameter can be applied between two or more subsequent cadencing event (CE) positions, thereby distorting the original segment and accelerating the shader parameter before a given CE, and decelerating it after the CE.

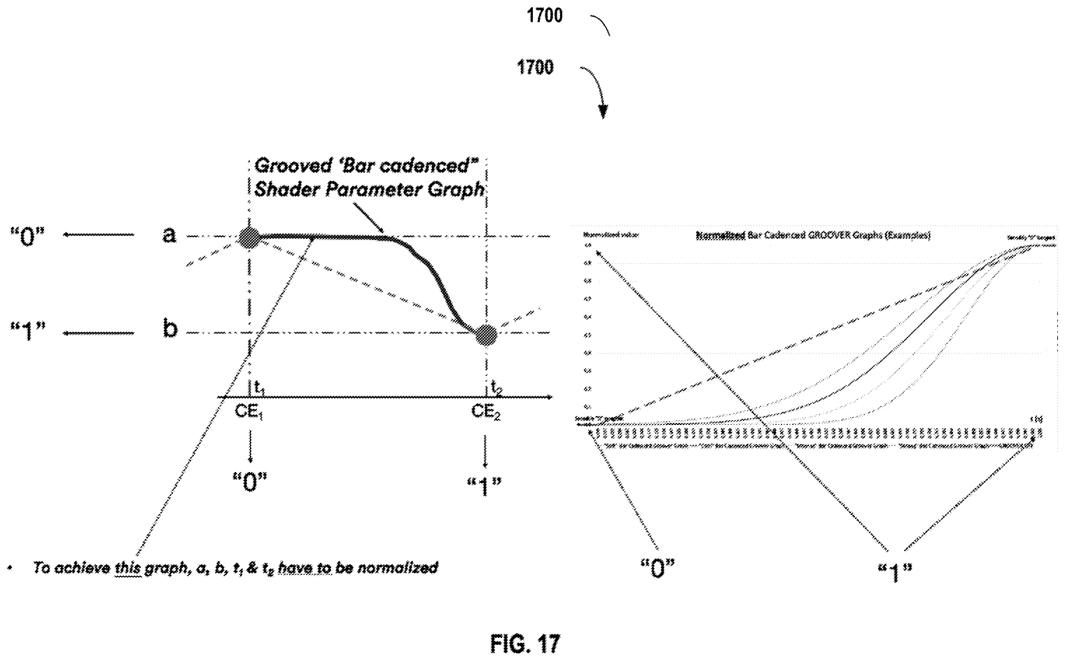

FIG. 17 provides an example graph 1700 illustrating the application of groover graphs to bar cadenced shader parameters. In particular, the example of FIG. 17 illustrates one example of how groover graph values can be re-normalized, for example, for application between two cadenced events (CEs). In the example illustrated by FIG. 17, t₁ can be 34.5 s, and t₂ can be 35.9 s; given these values, the abscissa positions of the groover graph need to be compressed such that the time difference between t₁ and t₂ is 1.0 s (rather than 1.4 s). Similar compressions can be performed for ordinate positions, for example, assuming that the Groover graph is calibrated for a duration of 1 s, and feature ordinate values fall in the range of [0, 1].

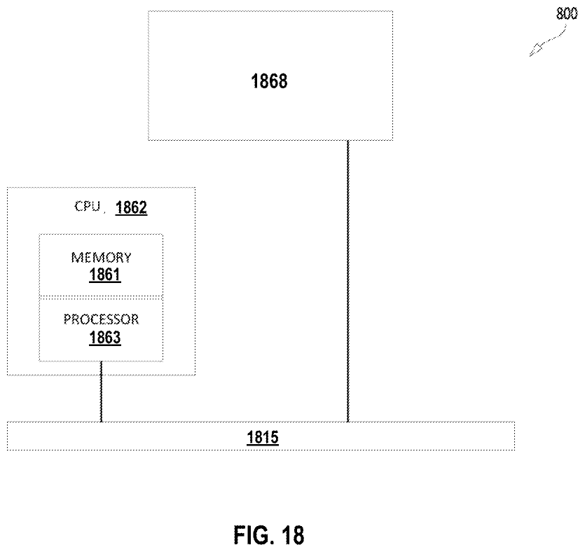

FIG. 18 illustrates an example processor-based device 1800 that can be used to implement various aspects of the technology. For example, processor-based device 1800 can be configured to perform the processing necessary to calculate a groover graph information for one or more media content items, and/or to perform the processing and calculation needed to determine and apply time-compression and/or time-stretching adjustments to an existing groover graph.

It is further understood that the processor-based device 1800 may be used in conjunction with one or more other processor-based devices, for example, as part of a computer network or computing cluster. Processor-based device 1800 includes a master central processing unit (CPU) 1862, interfaces 1868, and a bus 1815 (e.g., a PCI bus). CPU 1862 preferably accomplishes all these functions under the control of software including an operating system and any appropriate applications software. CPU 1862 can include one or more processors 1863 such as a processor from the Motorola family of microprocessors or the MIPS family of microprocessors. In an alternative embodiment, processor 1863 is specially designed hardware for controlling the operations of processor-based device 1800. In a specific embodiment, a memory 1861 (such as non-volatile RAM and/or ROM) also forms part of CPU 1862. However, there are many different ways in which memory could be coupled to the system.

Interfaces 1868 can be provided as interface cards (sometimes referred to as “line cards”). Generally, they control the sending and receiving of data packets over the network and sometimes support other peripherals used with the router. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 1862 to efficiently perform routing computations, network diagnostics, security functions, etc.

Although the system shown in FIG. 18 is one specific network device of the present invention, it is by no means the only device architecture on which the present invention can be implemented. For example, an architecture having a single processor that handles communications as well as routing computations, etc. is often used. Further, other types of interfaces and media could also be used with the router.

Regardless of the network device's configuration, it may employ one or more memories or memory modules (including memory 1861) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

What is claimed is:

1. A method comprising:
identifying an audio event trigger and a frame playback rate of a multimedia content item; and
adjusting a set of image frames of the multimedia content item based on the identified audio event trigger by using a groover graph to locally accelerate or decelerate the frame playback rate for the set of image frames surrounding the audio event trigger, wherein the groover graph includes a set of time offsets that can be applied to a timing of the image frames with respect to a temporal position of the audio event trigger, and wherein shifting is greatest for times nearest to the temporal position.

2. The method of claim 1, further comprising:
playing back an adjusted multimedia content item based on the adjusted frames, wherein an overall duration of the adjusted multimedia content item is equal that of the multimedia content item.

3. The method of claim 1, wherein a magnitude of an applied time offset is based on a distance from the audio event trigger and wherein once the audio event trigger has passed, the magnitude of the applied time offset decreases after the audio event trigger has passed or the frame playback rate resumes to a normal speed.

4. The method of claim 3, wherein at the trigger time position, the magnitude of the applied time offset is greater when a corresponding audio event is of a high-intensity, and lower when the corresponding audio event is of a low-intensity.

5. The method of claim 1, further comprising:
determining the audio event trigger using a beat decomposition process that generates event vectors including time-index information, wherein the event vectors indicate temporal locations of the audio event trigger.

6. A method comprising:
identifying an audio event trigger and a shader parameter course;
wiring a shader to one or more event vectors to automatically trigger certain graphical effects at times associated with the one or more of the event vectors during playback of an adjusted multimedia content item, wherein the shader is a function used to modify an appearance of a set of image frames; and
locally accelerating or decelerating, at the identified audio event trigger, the shader parameter course by using a groover graph.

7. The method of claim 6, further comprising:
determining the audio event trigger using a beat decomposition process that generates event vectors including time-index information, wherein the event vectors indicate temporal locations of the audio event trigger.

8. The method of claim 7, wherein the audio event trigger is a rhythm audio event or a playback of a combination of different instrument types.

9. The method of claim 6, wherein an acceleration level of the parameter course is based on a distance from the audio event trigger and wherein once the audio event trigger has passed or a deceleration level decreases after the audio event trigger has passed.

10. The method of claim 6, further comprising:
modifying a shader parameter using the groover graph based on one or more groover triggers, wherein the groover graph is applied to a trigger time position, wherein a groover graph strength is modulated by a normalized audio intensity of the identified second audio trigger event.

11. A system comprising:
one or more processors; and
a computer-readable medium coupled to the processors, the computer-readable medium comprising instructions stored therein, which when executed by the processors, cause the processors to perform operations comprising:
identifying a first audio event trigger and a frame playback rate of a multimedia content item;
adjusting a set of image frames of the multimedia content item based on the identified first audio event trigger by using a groover graph to locally accelerate or decelerate the frame playback rate for the set of image frames surrounding the identified first audio event trigger, wherein the groover graph includes a set of time offsets that can be applied to a timing of the image frames with respect to a temporal position of the identified first audio event trigger, and wherein shifting is greatest for times nearest to the temporal position;
identifying a second audio event trigger and a shader parameter course;
wiring a shader to one or more event vectors to automatically trigger certain graphical effects at times associated with the one or more of the event vectors during playback of an adjusted multimedia content item, wherein the shader is a function used to modify an appearance of a second set of image frames; and
locally accelerating or decelerating, at the identified second audio event trigger, the shader parameter course by using the groover graph.

12. The system of claim 11, wherein the processors are further configured to execute operations comprising:
playing back the adjusted multimedia content item based on the adjusted frames, wherein an overall duration of the adjusted multimedia content item is equal that of the multimedia content item.

13. The system of claim 12, wherein a magnitude of an applied time offset is based on a distance from the identified first audio event trigger and wherein once the identified first audio event trigger has passed, the magnitude of the applied time offset decreases after the identified first audio event trigger has passed or the frame playback rate resumes to a normal speed.

14. The system of claim 13, wherein at the trigger time position, the magnitude of the applied time offset is greater when a corresponding audio event is of a high-intensity, and lower when the corresponding audio event is of a low-intensity.

15. The system of claim 11, wherein the processors are further configured to execute operations comprising:
determining the identified second audio event trigger using a beat decomposition process that generates event vectors including time-index information, wherein the event vectors indicate temporal locations of the identified second audio event trigger.

16. The system of claim 15, wherein the identified second audio event trigger is a rhythm audio event or a playback of a combination of different instrument types.

17. The system of claim 15, wherein an acceleration level of the parameter course is based on a distance from the identified second audio event trigger and wherein once the identified second audio event trigger has passed or a deceleration level decreases after the identified second audio event trigger has passed.

18. The system of claim 15, wherein the processors are further configured to execute operations comprising:
modifying a shader parameter using the groover graph based on one or more groover triggers, wherein the groover graph is applied to a trigger time position, wherein a groover graph strength is modulated by a normalized audio intensity of the identified second audio trigger event.
